(19) United States
(12) Patent Application Publication
(10) Pub. No.: US 2005/0038132 A1
(43) Pub. Date: Feb. 17, 2005

(54) Composition for forming a foamed article and an article of furniture having the foamed article disposed therein

(76) Inventors: Raghuram Gummaraju, Novi, MI (US); Gene M. Scheffler, Browns, MI (US); Heinz Plaumann, Browns, MI (US); Theodore M. Smiecinski, Woodhaven, MI (US); Todd J. Green, Canton, MI (US)

Correspondence Address: BASF CORPORATION;LEGAL DEPARTMENT, 1609 BIDDLE AVENUE, WYANDOTTE, MI, 48192, US

(21) Appl. No.: 10/892,413

(22) Filed: Jul. 15, 2004

Related U.S. Application Data
(63) Continuation-in-part of application No. 10/391,925, filed on Mar. 19, 2003, now Pat. No. 6,797,736.

(51) Int. Cl. C08G 18/00

(52) U.S. Cl. 521/155

(57) ABSTRACT

The subject invention provides a foamed article having random cell structures formed by a process comprising the steps of providing a resin component and an isocyanate component and providing a first nucleation gas and a second nucleation gas, both under low pressure. The first and the second nucleation gases are added into at least one of the resin component and the isocyanate component. The resin component and the isocyanate component are reacted to form the foamed article having a first cell structure resulting from the addition of the first nucleation gas and a second cell structure that is different than the first cell structure resulting from the addition of the second nucleation gas. The foamed article is particularly suited for replacing metal springs in an article of furniture while still maintaining the feel and comfort of the metal springs.

### CROSS-REFERENCE TO RELATED APPLICATIONS

This application is a continuation-in-part of application Ser. No. 10/391,925 filed Mar. 19, 2003.

### BACKGROUND OF THE INVENTION

1) Field of the Invention

The subject invention relates to a composition for forming a foamed article having random cell structures as a result of use of a first nucleation gas and a second nucleation gas, both under low pressure. Additionally, the subject invention relates to an article of furniture having the foamed article disposed therein.

2) Description of Related Art

High resilience, flexible polyurethane foams are produced by reacting an isocyanate with an isocyanate-reactive component containing two or more reactive sites, generally in the presence of blowing agents, catalysts, surfactants and other auxiliary additives. One method of forming the polyurethane foam is with a slabstock process known to those skilled in the polyurethane foam art. The isocyanate-reactive components are typically polyether polyols, polyester polyols, primary and secondary polyamine polyols, or water. The catalysts used during the preparation of the polyurethane foam promote two major reactions among the reactants, gelling and blowing. These reactions must proceed simultaneously and at a balanced rate during the process in order to yield polyurethane foam with desired physical characteristics. In order for the polyurethane foams to be flexible, the polyurethane foams are generally open-celled materials, which may require additional processing, such as crushing, to reach a desired openness.

Polyurethane foam produced via slabstock processes is prepared in a foam machine that mixes the individual reactants, i.e., isocyanate, isocyanate-reactive components, and additives, in a continuous manner through a mix head and deposits the reaction product into a trough. The product begins to froth and rise out of the trough and overflows onto fall plates. On the fall plates, the product continues to rise and contacts a conveyor. The product cures as the conveyor carries it along a length forming the polyurethane foam in a large slab. The conveyors are typically lined with a paper or plastic liner to allow for easy removal of the polyurethane foam. As the polyurethane foam exits the machine, it is cut into large blocks.

Various related art patents disclose methods of forming polyurethane foams formed via slabstock processes. These methods include using blowing agents such as water, air, nitrogen, or carbon dioxide, as shown in U.S. Pat. No. 5,403,088. Typically, carbon dioxide liquid is added directly to the polyol component, however it is also known in the art that it can be added to either or both components. The polyol component supply must be pressurized to maintain the carbon dioxide in the liquid state. As the product exits the mix head and as it froths and rises, the carbon dioxide changes states from a liquid to a gas and acts as a blowing agent. One primary reason for adding the carbon dioxide in a liquid state is to ensure that there is a sufficient amount of blowing agent to produce the polyurethane foam having a desired density. However, one disadvantage of using liquid carbon dioxide is that the polyol component supply must be under pressure, which is expensive and can be dangerous to maintain the high pressures.

Yet another method, shown in U.S. Pat. No. 5,360,831, discloses adding carbon dioxide gas as a nucleation gas into either one of the polyol component or the isocyanate component streams for a foam-in-fabric process. The carbon dioxide gas thickens and increases the viscosity of the foaming mass to prevent the reacting components from entering the fine pores of the polyurethane foam and fabric capsule, which allows these encapsulating materials to remain as is, functional, not compromised. In a foam-in-fabric process, fabric is positioned within the mold and the components are mixed together and poured into the fabric. The components react, forming foam that fills the fabric and forms the final product. Foam-in-fabric processes are different from slabstock foam processes in that the foam-in-fabric process is prepared in a batch process and makes only enough foam to fill a mold, whereas the slabstock process involves continuous reacting of the components.

The use of other blowing agents, such as nitrogen gas or various other gases, is shown in WO 02/10245. One distinguishing factor between a blowing agent and a nucleation gas is the amount used and the effect that the blowing agent has on the polyurethane foam in the slabstock process. Typically, when a gas is added as a blowing agent, a large amount of the blowing agent is needed to expand the polyurethane foam during the frothing and rising stages to control the density of the polyurethane foam. The addition of more blowing agents results in a lower density polyurethane foam.

One example of a conventional article of furniture is illustrated generally at 10 in FIG. 1 (Prior Art). The article of furniture 10 includes a base portion 12 defining a cavity 14 with a back portion 16 extending upwardly from the base portion 12. Metal springs 18 are disposed within the cavity 14 for providing support to a user seated upon the article of furniture 10. The metal springs 18 are housed in the cavity 14 by an upper support 20 and a lower support 22.

Those in the furniture industry have attempted to replace the metal springs with foamed articles. Examples of articles of furniture having foamed articles disposed therein are illustrated in U.S. Pat. Nos. 2,849,058; 3,642,323; and 3,088,133. However, to date, the industry has been unsuccessful in producing the article of furniture having the feel of the metal springs. Specifically, in the '058 and '323 patents, multiple layers of foam are used with each of the layers having varying physical properties in an attempt to reproduce the feel and the comfort of the metal springs. However, even with multiple layers of foam, the properties of the foam will not produce the desired feel of the metal springs. The '133 patent uses a single layer of foam, but the foam does not have the required physical properties to provide the feel of the metal springs. Specifically, the article of furniture illustrated in the '133 patent requires additional members to prevent the foam from deforming under the weight of the user.

In summary, the articles of furniture in the related art that incorporate foamed articles do not produce a feel and comfort similar to that of articles of furniture incorporating traditional metal springs. The related art foamed articles do not have the desired properties of the metal springs and therefore do not produce a satisfactory feel and comfort.

### BRIEF SUMMARY OF THE INVENTION

The subject invention provides a foamed article having random cell structures and a composition for forming the foamed article. The foamed article is formed by providing a resin component and an isocyanate component and providing a first nucleation gas under low pressure. The first nucleation gas is added into at least one of the resin component and the isocyanate component. A second nucleation gas, also under low pressure, is provided and is added into at least one of the resin component and the isocyanate component. The second nucleation gas is different than the first nucleation gas. The resin component and the isocyanate component are reacted to form the foamed article. The foamed article has a first cell structure resulting from the addition of the first nucleation gas and a second cell structure that is different then the first cell structure. The second cell structure results from the addition of the second nucleation gas.

The subject invention further provides an article of furniture comprising a frame and the foamed article. The frame has a base portion defining a cavity free of metal springs with a back portion extending upwardly from the base portion. The foamed article is disposed within the cavity and replaces the metal springs. Due to the first and the second nucleation gases and the resulting first and second cell structure, the foamed article produces the article of furniture having a comfort and feel similar to that of the traditional metal springs.

Accordingly, the subject invention provides the article of furniture that includes the foamed article to replace traditional metal springs and to reproduce the feel and comfort of the traditional metal springs. More over, the foamed article satisfies the need of producing a substitute for the metal springs without sacrificing feel and comfort. The foamed article is preferred to the metal springs due to a improved durability of the foamed article and an ease of manufacturing the article of furniture without the metal springs.

### BRIEF DESCRIPTION OF THE SEVERAL VIEWS OF THE DRAWING

Other advantages of the present invention will be readily appreciated, as the same becomes better understood by reference to the following detailed description when considered in connection with the accompanying drawings wherein:

FIG. 1 is a partial cross-sectional view of a prior art article of furniture having a base portion defining a cavity with metal springs disposed therein;

FIG. 2 is a perspective view a slabstock foam forming machine having an isocyanate supply line and an isocyanate-reactive supply line being mixed with nucleation gases and additives prior to feeding into a mix head;

FIG. 3 is a close-up view from a scanning electron microscope of a foamed article made in accordance with the subject invention illustrating the first and the second cell structures;

FIG. 4 is a perspective view of an article of furniture with the foamed article replacing the metal springs;

FIG. 5 is a partial cross-sectional view of the article of furniture illustrated in FIG. 4; and

FIG. 6 is a graphical representation of a hysteresis curve comparing a high resilience slabstock polyurethane foam formed according to the subject invention with a latex foam.

### DETAILED DESCRIPTION OF THE INVENTION

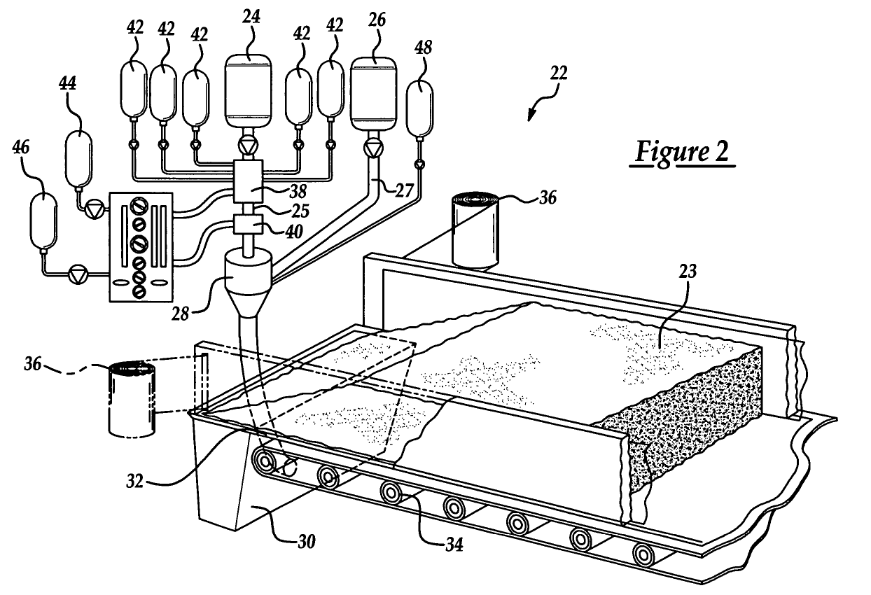

Referring to the Figures, wherein like numerals indicate like or corresponding parts throughout the several views, a slabstock foam forming machine is shown generally at 22 in FIG. 2. The machine 22 is used for forming high resilience (HR) polyurethane foam 23 having random cell structures. The random cell structures produce desired feel and characteristics in the polyurethane foam. The slabstock foam machine 22 includes a resin supply tank 24 and an isocyanate supply tank 26. The resin supply tank 24 supplies a resin component through a resin supply line 25 and the isocyanate supply tank 26 supplies an isocyanate component through an isocyanate supply line 27. Both supply lines 25, 27, feed continuously into a mix head 28 for mixing the two components, as they flow through the mix head 28. The mixture of the components initiates a reaction and is continuously deposited into a trough 30. The mixture continues to react in the trough 30 and begins to froth as is known the art. The mixture rises and overflows from the trough 30 onto fall plates 32. The mixture then contacts a conveyor 34 and is carried away from the fall plates 32. The mixture continues to rise along the conveyor 34 and begins to cure forming the polyurethane foam 23. As the polyurethane foam 23 reaches the end of the conveyor 34, it is cut into blocks of various sizes depending upon the application to form a foamed article 35. The conveyor 34 is lined with a release material 36 to ensure movement of the polyurethane foam 23 along the conveyor 34.

The resin supply line 25 may include a first manifold 38 and a second manifold 40 disposed upstream from the mix head 28. A first nucleation gas supply tank 44 and a second nucleation gas supply tank 46 are illustrated connecting to the first and the second manifolds 38, 40. It is to be appreciated that these the first and the second nucleation gas supply tanks 44, 46 may be alternatively connected as described further below. Each of the manifolds 38, 40 has at least one inlet for adding additional components 42 to the resin supply line 25. These additional components 42 may include at least one of a surfactant, a chain extender, a catalyst, a colorant, a flame retardant, and the like. Alternately, the manifolds may be on the isocyanate supply line 27 or on both supply lines. A blowing agent supply tank 48 is illustrated connected to the mix head 28.

The foamed article 35 is formed from a composition comprising the resin component, the isocyanate component, a first nucleation gas, and a second nucleation gas different than the first nucleation gas. While in a gaseous state, the first nucleation gas may be disposed in one of the resin component or the isocyanate component and forms a first cell structure in the foamed article 35. Also while in a gaseous state, the second nucleation gas may be also disposed in one of the resin component or the isocyanate component for forming a second cell structure in the foamed article 35 that is different than the first cell structure. It is believed that these novel cell structures improve the physical properties of the foamed article 35.

The resin component includes an isocyanate-reactive component and a graft dispersion. The isocyanate-reactive component may include polyhydroxyl-containing polyesters, polyoxyalkylene polyether polyols, polyhydroxy-terminated polyurethane polymers, polyhydroxyl-containing phosphorous compounds, and alkylene oxide adducts of polyhydric polythioesters, polyacetals, aliphatic polyols and thiols, ammonia, and amines including aromatic, aliphatic, and heterocyclic amines, as well as mixtures thereof. Alkylene oxide adducts of compounds which contain two or more different groups within the above-defined classes may also be used, for example, amino alcohols which contain amino groups and a hydroxyl group. Also, alkylene oxide adducts of compounds which contain one SH group and one OH group as well as those which contain an amino groups and an SH group may be used.

Any suitable hydroxy-terminated polyester polyol may be used such as those that are prepared, for example, from polycarboxylic acids and polyhydric alcohols. Any suitable polycarboxylic acid may be used such as oxalic acid, malonic acid, succinic acid, glutaric acid, adipic acid, pimelic acid, suberic acid, azelaic acid, sebacic acid, brassylic acid, maleic acid, fumaric acid, glutaconic acid, α-hydromuconic acid, β-hydromuconic acid, α-butyl-α-ethyl-glutaric acid, α, β-diethylsuccinic acid, isophthalic acid, terephthalic acid, hemimellitic acid, and 1,4-cyclohexanedicarboxylic acid. Any suitable polyhydric alcohol, including both aliphatic and aromatic, may be used such as ethylene glycol, propylene glycol, trimethylene glycol, 1,2-butane diol, 1,3-butanediol, 1,4-butanediol, 1,2-pentanediol, 1,4-pentanediol, 1,5-pentanediol, 1,6-hexanediol, 1,7-heptanediol, glycerol, 1,1,1-trimethylolpropane, 1,1,1-trimethylolethane, 1,2,6-hexanetriol, α-methyl glucoside, pentaerythritol, and sorbitol. Also included within the term “polyhydric alcohols” are compounds derived from phenol such as 2,2-bis(4-hydroxylphenyl)propane, commonly known as Bisphenol A.

Any suitable polyoxyalkylene polyether polyol may be used such as the polymerization product of an alkylene oxide or a mixture of alkylene oxides with a polyhydric alcohol as an initiator. Examples of alkylene oxides include ethylene oxide, propylene oxide, butylene oxide, amylene oxide, and mixtures thereof, tetrahydrofuran, alkylene oxide-tetrahydrofuran mixtures, epihalohydrins, and aralkylene oxides such as styrene oxide. Suitable initiators include both aliphatic and aromatics alcohols, such as ethylene glycol, diethylene glycol, propylene glycol, dipropylene glycol, trimethylene glycol, 1,2-butanediol, 1,3-butanediol, 1,4-buanediol, 1,2-pentanediol, 1,4-pentanediol, 1,5-pentanediol, 1,6-hexanediol, 1,7-heptanediol, glycerol, 1,1,1-trimethylolpropane, 1,1,1-trimethylolethane, 1,2,6-hexanetriol, α-methyl glucoside, pentaerythritol, sorbitol, and 2,2-bis(4-hydroxyphenyl)propane.

The polyoxyalkylene polyether polyols may have either secondary hydroxyl groups or a mixture of primary and secondary hydroxyl groups. If the latter, the mixture should have a majority of secondary hydroxyl groups. Included among the polyether polyols are polyoxyethylene glycol, polyoxypropylene glycol, polyoxypropylene glycerine, polyoxybutylene glycol, polytetramethylene glycol, block copolymers, for example, combinations of polyoxypropylene and polyoxyethylene glycols, poly-1,2-oxybutylene and polyoxyethylene glycols, poly-1,4-oxybutylene and polyoxyethylene glycols, and random copolymer glycols prepared from blends of two or more alkylene oxides or by the sequential addition of two or more alkylene oxides. The polyoxyalkylene polyether polyols may be prepared by any known process such as, for example, the process disclosed by Wurtz in 1859, Encyclopedia of Chemical Technology, Vol. 7, pp. 257-262, published by Interscience Publishers, Inc. (1951) or in U.S. Pat. No. 1,922,459.

The isocyanate-reactive component is preferably is selected from at least one of polyether polyols and polyester polyols. The polyether polyol has a hydroxyl number of from 10 to 100; preferably from 15 to 80; and most preferably from 20 to 60. The polyether polyol has a functionality of from 1 to 8; preferably from 2 to 4; and most preferably from 2.2 to 3.2, and an % ethylene oxide content of from 0 to 30; preferably from 5 to 25; and most preferably from 10 to 20. An example of suitable commercially available polyols include, but are not limited to, PLURACOL® 2100, 220, 380, 381, 538, 593, 718, 945, 1051, 1385, 1388, 1509, 1538, and 1718, which are commercially available from BASF Corporation.

Graft dispersions are well-known in the art and one method of preparing graft dispersions is by in situ polymerization of one or more vinyl monomers, preferably acrylonitrile and styrene, in the presence of a polyether or polyester polyol, especially polyols containing a minor amount of natural or induced unsaturation. This method forms the graft dispersion commonly referred to as polymer polyols, graft polyols, or graft polyol dispersions. Other graft dispersions that may be used with the subject invention include polyhamstoff dispersions' (PHD) polyols and polyisocyanate polyaddition (PIPA) polyols. PHD polyols are polyurea dispersions and PIPA polyols are polyurethane dispersions.

In the preferred embodiment, the graft dispersion includes at least one of polyacrylonitrile or polystyrene and has a solids content of from 0 to 60; preferably from 4 to 40; and most preferably from 6 to 25, based on 100 parts by weight of the graft dispersion. More preferably, the graft dispersion has a hydroxyl number within the range of from 0 to 80; preferably from 10 to 60; and most preferably from 20 to 40. An example of suitable commercially available graft polyols include, but are not limited to, PLURACOL® 973, 1117, 1365, 1441, 1442, 1491, 1543, 2115, 2120, 2130 and 2145 which are commercially available from BASF Corporation.

The isocyanate component is selected from at least one of diphenylmethane diisocyanate, toluene diisocyanate, hexamethylene diisocyanate, isophorone diisocyanate, and mixtures thereof. Preferably, the isocyanate component is selected from at least one of diphenylmethane diisocyanate, toluene diisocyanate, and mixtures thereof. An example of suitable isocyanates include, but are not limited to, LUPRANATE® MS, M20S, MI, M10, M70, M200, MM103, No. 236 Iso, No. 233 Iso, No. 278 Iso and No. 280 Iso which are commercially available from BASF Corporation.

The first nucleation gas is provided under low pressure and is added into at least one of the isocyanate-reactive component and the isocyanate component to produce the first cell structure in the polyurethane foam. The first nucleation gas is selected from at least one of carbon dioxide gas and nitrogen gas. It is to be appreciated by those skilled in the art that the first nucleation gas is added in a gaseous state. Therefore, by under low pressure, it is understood that the pressure is low enough for the first nucleation gas to be in the gaseous state, as opposed to a liquefied state. Preferably, the pressure is between 1/10^{th} to 8 atmospheres and the most preferred pressure is about 4 atmospheres. Preferably, the first nucleation gas is added into the isocyanate-reactive component and is carbon dioxide gas. However, it is to be appreciated that other gases may behave chemically similar to that of the carbon dioxide gas and may be used with the subject invention.

The second nucleation gas is different than the first nucleation gas. The second nucleation gas is provided under low pressure. The second nucleation gas is selected from at least one of carbon dioxide gas and nitrogen gas. It is to be appreciated by those skilled in the art that the second nucleation gas is added in a gaseous state. Therefore, by under low pressure, it is understood that the pressure is low enough for the second nucleation gas to be in the gaseous state, as opposed to a liquefied state. Preferably, the pressure is less than 3 atmospheres. The second nucleation gas is added into at least one of the isocyanate-reactive component and the isocyanate component to produce the second cell structure in the polyurethane foam different than the first cell structure. Preferably, the second nucleation gas is added into the isocyanate-reactive component and is nitrogen gas. However, it is to be understood that other gases may behave chemically similar to that of the nitrogen gas and may be used with the subject invention.

The second nucleation gas is preferably added in a ratio of from 1:1 to 1:10 relative to the addition of the first nucleation gas. More preferably, the second nucleation gas is added in a ratio of from 1:1 to 1:4 relative to the addition of the first nucleation gas. In other words, more of the first nucleation gas is added relative to the second nucleation gas. If too much of the first nucleation gas is added relative to the second nucleation gas, then the cell structure of the foamed article 35 may be too random or not random enough to produce the desired feel and characteristics. For descriptive purposes only, the subject invention will be described below only in terms of the preferred first and second nucleation gases.

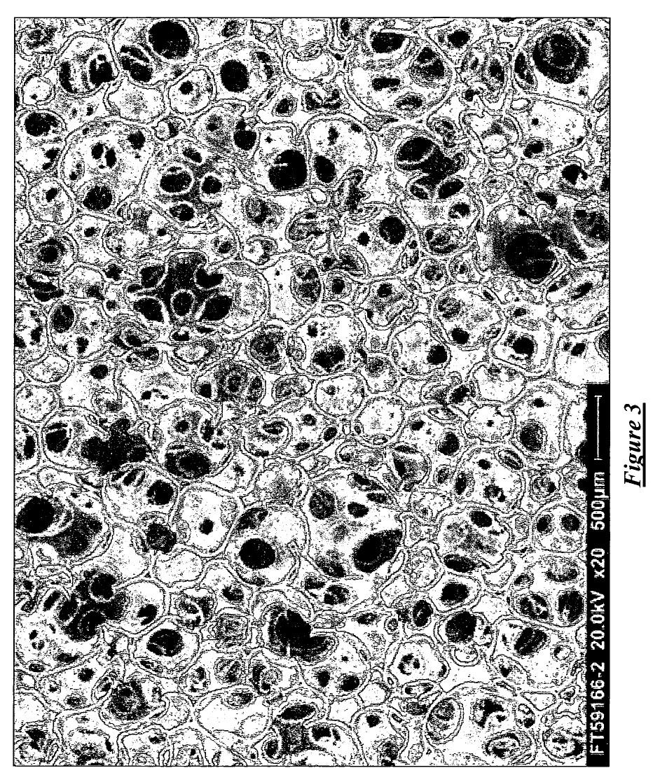

It is important to have a balance between the carbon dioxide gas and the nitrogen gas, because the gases compliment one another. The uniform first cell structure produced by the carbon dioxide gas is broken up by the irregular second cell structure of the nitrogen gas and vice versa. Together, both gases produce the foamed article 35 with the desired performance characteristics. Specifically, the larger, irregular sized second cell structure improves the resilience of the foamed article 35 and the smaller, regular sized first cell structure improves the appearance and feel of the foamed article 35. Referring to FIG. 3, a close-up view from a scanning electron mcroscope illustrates the foamed article 35 formed with the two nucleation gases. The first cell structure is smaller and uniform and the second cell structure is larger and random. Both cell structures are visible in FIG. 3. The first cell-structure is formed by carbon dioxide gas. This cell-structure is smaller, more uniform and fills the interstitial spacing between the larger, more irregular cells of the second cell-structure formed by nitrogen gas.

Depending upon the types of isocyanate-reactive component, isocyanate component, nucleation gases, or additives, the first nucleation gas may be added in the isocyanate-reactive component, while the second nucleation gas is added in the isocyanate component. Alternately, the first nucleation gas may be added into the isocyanate component, while the second nucleation gas may be added into the isocyanate-reactive component. In another embodiment, the first nucleation gas may be added into the isocyanate-reactive component and the second nucleation gas may be added into the isocyanate-reactive component.

A blowing agent, may also be used in forming the foamed article 35. Preferably the blowing agent is water, but may include freon, dichloromethane, acetone, liquid carbon dioxide, chloroflurocarbons, chlorinated solvents like methylene chloride or trichloroethane, or low-boiling point solvents is also added to the mix head 28. The blowing agent reacts with isocyanate component to generate hard segments commonly exhibited in preparation of polyurethane flexible slab foam.

The composition may also include additives selected from at least one of a surfactant, a chain extender, a cross-linker, a catalyst, a colorant, and a flame retardant. Various types of catalyst known to those skilled in the art include, but are not limited to, amine catalysts or tin catalysts. It is to be appreciated that other additives known to those skilled in the art may be added without deviating from the subject invention.

The composition described above forms the foamed article 35 via a process that includes the step of providing the resin component and the isocyanate component. It is preferable that the resin component is supplied at a rate of from 10 to 500 kilograms per minute and the isocyanate component is supplied at a rate of from 5 to 250 kilograms per minute. The isocyanate component may also be supplied at a pressure of from 10 to 2000 pounds per square inch gauge. The rate of addition of the resin components and isocyanate components depends upon the size of the foamed article 35 to be formed. These rates can be used to produce foamed article 35 having a height of from 1 to 50 inches and a width of from 12 to 120 inches. If the resulting foamed article 35 were larger, then these amounts would be increased.

The process includes the steps of providing the first nucleation gas under low pressure and adding the first nucleation gas into at least one of the resin component and the isocyanate component. The first nucleation gas may be added at a rate of from 0.1 liters per minute to 30 liters per minute. Preferably, the first nucleation gas is added at a rate of from 2 liters per minute to 20 liters per minute. Most preferably, the first nucleation gas is added at a rate of from 5 liters per minute to 15 liters per minute. If too much carbon dioxide gas is added, then the first cell structure will be too uniform and too fine, which results in the foamed article 35 not having the desired properties. If too little carbon dioxide gas is added, then the first cell structure is too random and large and not uniform or fine enough.

The process also includes the step of providing the second nucleation gas under low pressure different than the first nucleation gas under low pressure and adding the second nucleation gas into at least one of the resin component and the isocyanate component. The resin component and the isocyanate component are reacted to form the foamed article 35 having the first cell structure resulting from the addition of the first nucleation gas and the second cell structure that is different than the first cell structure resulting from the addition of the second nucleation gas.

The reaction preferably takes place when the resin component and the isocyanate component are mixed through the mix head 28. The second nucleation gas is provided at a rate of from 0.1 liters per minute to 20 liters per minute. Preferably, the second nucleation gas is provided at a rate of from 1 liter per minute to 10 liters per minute. Most preferably, the second nucleation gas is provided at a rate of from 2 liters per minute to 6 liters per minute. If too much nitrogen gas is added, then the second cell structure becomes too irregular, which results in the foam having large voids or “pea holes” and the foam is unacceptable. If too little nitrogen gas is added, then the second cell structure is too uniform, which does not produce the desired feel and characteristics.

The subject invention further includes the step of adding at least one additive into at least one of the resin component and the isocyanate component. Preferably, the additives are added into the resin component supply line, as illustrated in FIG. 2.

The subject invention is particularly useful when the foamed article 35 prepared by the above process has a density of greater than about 4 pounds per cubic foot. Those skilled in the art recognize that a density of greater than about 4 pounds per cubic foot is considered to be a high density foam. There are various other physical properties that allow the high density foam to be used in novel applications. The usual density range is between 1 to 10 pcf, preferably from 2 to 6 pcf, and most preferably from 3 to 5 pcf.

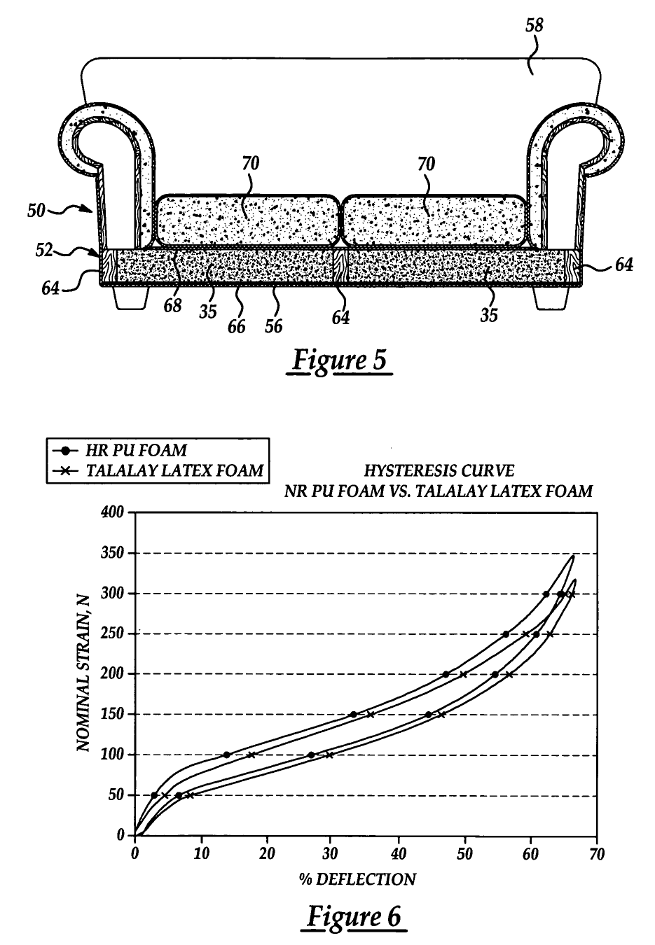

For example, the foamed article 35 is particularly useful in an article of furniture 50 as illustrated in FIGS. 4 and 5. Referring to FIG. 4, the article of furniture 50 has a frame 52 having a base portion 54 defining a cavity 56 free of metal springs. A back portion 58 extends upwardly from the base portion 54. The foamed article 35 is disposed within the cavity 56 and has desired characteristics and properties as a result of the first cell structure and the second cell structure. The characteristics and properties allow the foamed article 35 to replace the metal springs of the article of furniture 50 without sacrificing comfort and feel. Specifically, the article of furniture 50 can be manufactured without using any metals springs while still obtaining satisfactory comfort and feel. One shortcoming of the related art articles of furniture is that they do not produce a feel that is similar to that of traditional furniture. Said another way, the related art foamed articles incorporated into the articles of furniture do not reproduce the feel of the metal springs. To date, the furniture industry has been unable to produce the article of furniture 50 incorporating the foamed article 35 that reproduces the feel of the traditional metals springs.

The base portion 54 of the article of furniture 50 includes a front support 60, a rear support 62, and side supports 64 defining the cavity 56. Preferably, the foamed article 35 is co-extensive with the front support 60, the rear support 62, and the side supports 64. The foamed article 35 is co-extensive such that it is friction fit within the cavity 56 and requires no additional fasteners to hold the foamed article 35 within the cavity 56. Referring to FIG. 4, a bottom support 66, which is preferably a fabric material, is stretched across and engages the front support 60, the rear support 62, and the side supports 64 for supporting the foamed article 35 within the cavity 56. A cover 68 engages the front support 60, the rear support 62, and the side supports 64 for covering the cavity 56 and the foamed article 35. Traditionally, an additional pillow 70 would be placed upon the cover 68 to complete the article of furniture 50.

The foamed article 35 formed according to the subject invention reproduces the feel of the metals springs such that users are unable to tell a difference. Key physical characteristics of the foamed article 35 were identified that imparts the traditional feel of the metals springs to the user. These characteristics where density, sag or support factor, resilience, and indentation force deflection (IFD). It has been determined that these characteristics individually do not produce the traditional feel, but it is the combination that results in the desired feel and characteristics which is similar to the metals springs.

Accordingly, in order to achieve the desired feel, the foamed article 35 preferably has the density of at least 4 pounds per cubic foot (pcf), a sag factor of from 2.0 to 3.5, a resilience of greater than 45% based on a steel ball rebound test, and an indentation force deflection (IFD) of from 20 pounds to 32 pounds for achieving a 25% indentation. When the density is less than about 4 pcf, the foamed article 35 provides a feel that the user is sinking into the article of furniture 50, which is undesirable. Also, density may vary from the polyurethane foam by up to 0.5 pcf, without effecting the feel.

IFD values are determined by measuring a force (Lb_{f}) required to press and hold an indentation foot into the sample. This value is sometimes referred to as an ILD number—Indentation Load Deflection and these terms are often used interchangeably. Because the surface area of the indentation foot used to conduct this test is 50 square inches, the units for the IFD value are Lb_{f}/50 in², though, in practice, this label is often dropped and just the value is reported. IFD tests are run by pressing the indentation foot into the foam a desired distance, such as 25 percent of the sample's original thickness. This deflection is then held for 60 seconds, and the force exerted by the foam back to the indentation foot is recorded. The sag factor is the amount of force required to achieve 65% IFD divided by the amount of force to achieve 25% IFD. Resilience of the sample is measured by dropping a steel ball from a predetermined height onto the sample and measuring a peak height that the ball bounces. The resilience is expressed in percent of the predetermined height.

### EXAMPLES

The foamed article 35 was prepared according to the subject invention having components in part by weight (pbw), unless otherwise indicated, set forth in Table 1. Table 1 includes three examples of the foamed article 35 to be made in a slabstock process such that the resulting articles have a different density and hardness. Specifically, one difference between Example 1 and Example 2 is isocyanate index. Isocyanate index is defined as the ratio of the NCO groups in the isocyanate component to the OH groups in the isocyanate-reactive components.

TABLE 1
Formulation of HR Slabstock Polyurethane Foam

| Formulation, pbw | Example 1 | Example 2 | Example 3 |
|---|---|---|---|
| Resin component | 100.0 | 100.0 | 100.0 |
| Colorant | 2.00 | 2.00 | 1.00 |
| Water | 1.50 | 1.50 | 1.50 |
| Cross-linker | 1.00 | 1.00 | 1.00 |
| Surfactant | 2.20 | 2.20 | 2.20 |
| Amine Catalyst | 0.30 | 0.30 | 0.30 |
| Tin Catalyst | 0.15 | 0.15 | 0.15 |
| Flame Retardant | 4.00 | 4.00 | 4.00 |
| Isocyanate Component | 20.57 | 18.51 | 18.38 |
| Isocyanate index | 100 | 90 | 90 |
| Total PBW | 132.5 | 130.4 | 128.5 |

The resin component is a blend of an isocyanate-reactive component and a graft dispersion. The isocyanate-reactive component is a single initiated polyol having greater than 50% propylene oxide and less than 50% ethylene oxide end capping. The isocyanate-reactive component has a functionality of about 3 and number-average molecular weight of about 5000 or weight-average molecular weight of about 6500. The isocyanate-reactive component is commercially available as PLURACOL® 2100 from BASF Corporation. The graft dispersion has a solids content of about 45 parts by weight based on 100 parts by weight of the graft dispersion and a 1:2 ratio of acrylonitrile to styrene. The graft dispersion has a hydroxyl number of 24 and the carrier polyol is a TMP-initiated polyol having >50% propylene oxide and <50% ethylene oxide end capping. The carrier polyol has a functionality of about 3. The graft dispersion is commercially available as PLURACOL® 2130 from BASF Corporation.

The colorant is Blue 8515, sold under the trademark REACTINT® commercially available from Milliken Chemical. The cross-linker is diethanolamine, commonly known as DEOA LF and is commercially available from Chemcentral. The surfactant is NIAX U-2000 Silicone, commercially available from GE Silicones. The amine catalyst includes DABCO® 33-LV, commercially available from Air Products and Chemicals, Inc., and DABCO® B11, commercially available from GE Silicones. The tin catalyst is DABCO® T-12, commercially available from Air Products and Chemicals, Inc. The flame retardant is ANTIBLAZE® 100, commercially available from Albamarle.

The isocyanate component is a mixture of 80% 2,4-isomers of toluene diisocyanate and 20% 2,6-isomers of toluene diisocyanate. The isocyanate component is commercially available as LUPRANATE® T-80 TDI from BASF Corporation.

Each of the above examples where processed in a slabstock polyurethane foam machine 22 according to the processing conditions set forth in Table 2.

TABLE 2
Processing Conditions for preparing HR Slabstock
Polyurethane Foam

| | Example 1 | Example 2 | Example 3 |
|---|---|---|---|
| Calibrations, Kg/min. | | | |
| Isocyanate component | 13.19 | 12.06 | 13.60 |
| Isocyanate-reactive | 64.20 | 65.20 | 65.00 |
| component | | | |
| Colorant | 1.30 | 1.30 | 0.00 |
| Water added | 0.85 | 0.87 | 0.81 |
| Cross-linker | 0.64 | 0.65 | 1.30 |
| Surfactant | 1.41 | 1.43 | 1.30 |
| Amine Catalyst | 0.18 | 0.18 | 0.18 |
| Tin Catalyst | 0.10 | 0.10 | 0.10 |
| Flame Retardant | 2.57 | 2.61 | 2.00 |
| Processing Conditions | | | |
| Temp. F. | 88 | 88 | 80 |
| Isocyanate Temp. F. | 67 | 67 | 67 |
| Isocyanate Pres., psi | 431 | 425 | 322 |
| Rm Temp. ° F./Humid %/Atm | 78/38/29.2 | 78/38/29.2 | 71/25/29.3 |
| Mixer Speed, RPM | 4500 | 4500 | 4000 |
| N2 Gas Pressure, psig | 25 | 25 | 50 |
| N2 Gas Flow Rate, L/m | 1.8 | 1.8 | 3.3 |
| CO2 Gas Pressure, psig | 38 | 38 | 26 |
| CO2 Gas Flow Rate, L/m | 6.0 | 6.0 | 9.0 |

The resulting foamed article 35 was allowed to cure 24-48 hours at room temperature. The foamed article 35 was cut into 4″ thick pieces for use in various tests. These various tests were also performed on latex foam samples as Comparative Examples 1 and 2 below. The latex foam sample was obtained from FoamOrder.com and was purchased as a Talalay Latex Twin Mattress. The latex foam was originally 6″ thick and was cut down two inches to a thickness of 4″.

The various tests included determining the density (lb/ft³ or pcf) of the sample, the 25% IFD value of the sample, and the sag, or support, factor for the sample. Another test measured a percentage of hysteresis loss, discussed more below and shown in FIG. 2, which is a loss of elasticity of the sample. These specific tests tend to indicate a “feel” of the foamed article 35 for comparative analysis to the latex foam. The IFD can be used to determine similarity of feel between the foamed article 35 and latex foam, but it is preferable to rely on both the density and IFD.

A tensile strength (lb/ft² or psi), elongation (%), and tear (lb/in or ppi) test were performed on each of the samples in accordance with ASTM D-3574. Tensile, tear, and elongation properties describe the ability of the material to withstand handling during manufacturing or assembly operations. Another test determined the resilience as described above.

The samples were also measured for their ability to withstand wear and tear according to ASTM D-3574 by being subjected to a pounding of a predetermined weight for 80,000 cycles. An original sample height was measured and an original amount of force was determined to reach a value of 40% IFD. Then the sample was subjected to a pounding of the predetermined weight for 80,000 cycles. The sample height was then remeasured and the percentage of height loss was determined. The amount of force required to reach 40% IFD was also determined and the percentage of 40% IFD loss was determined.

The results of each of the above tests are summarized in Table 3. Comparative Example 1 and 2 are a Talalay Latex foam as described above.

TABLE 3
Various Test Results for HR Polyurethane Foam vs. Latex Foam

| | | Comparative | | Comparative |
|---|---|---|---|---|
| | Example 1 | Example 1 | Example 2 | Example 2 |
| Physical Properties | | | | |
| Density, pcf | 3.87 | 4.33 | 4.29 | 4.36 |
| Tensile, psi | 25 | 6 | 23 | 8 |
| HTAG Tensile, psi | 23 | 6 | 21 | 4 |
| Elongation, % | 176 | 101 | 210 | 132 |
| HTAG Elongation, | 140 | 25 | 140 | 80 |
| % | | | | |
| Tear, ppi | 2.5 | 0.9 | 2.5 | 0.7 |
| Resilience, % | 60 | 54 | 55 | 62 |
| IFD, lb./50 sq. in. | | | | |
| (4 in.) | | | | |
| 25% | 25.3 | 25.7 | 20.0 | 19.8 |
| 65% | 68.8 | 65.9 | 58.8 | 56.2 |
| 25% Return | 22.0 | 19.9 | 17.3 | 15.0 |
| Support Factor | 2.72 | 2.57 | 2.94 | 2.83 |
| Recovery, % | 87 | 78 | 87 | 76 |
| Hysteresis, % | 20 | 30 | 21 | 30 |
| Fatigue Properties | | | | |
| Pounding, 13 | | | | |
| Height, % Loss | 1.1 | 1.0 | 1.3 | 1.0 |
| 40% IFD, % Loss | 11 | 20 | 11 | 23 |

Referring to Table 3, Example 1 and Comparative Example 1 have a density that is within 0.5 pcf of each other and an IFD value at 25% within 0.4 of each other. Therefore, Example 1 has a latex-like feel that is similar to that of Comparative Example 1. Example 1 has an increased support factor of 6% relative to that of Comparative Example 1 and an increase in the hysteresis percentage of 33%. Example 1 also has significantly better tensile, elongation, and tear properties as set forth in Table 3.

The hysteresis loss values for the HR slabstock polyurethane foam samples are significantly less than latex foam samples. This implies that the polyurethane foams will most likely retain their original characteristics after flexing. A hysteresis curve is shown in FIG. 6. The HR polyurethane foam had a better hysteresis retention and support value than latex foam as depicted by this curve comparison.

Example 2 and Comparative Example 2 have a density that is within 0.07 pcf of each other and an IFD value at 25% within 0.02. Therefore, Example 2 has a latex-like feel that is similar to that of Comparative Example 2. Example 2 has an increased support factor of 4% relative to that of Comparative Example 2 and an increase in the hysteresis percentage of 30%. Example 2 also has significantly better tensile strength, elongation, and tear properties as set forth in Table 3.

Example 3 produced the foamed article 35 having a density of 4.21 pcf and an IFD value of 23.6 at 25%. FIG. 3 is the close up view of the two cell structures that are a result of the two nucleation gases in Example 3. The foamed article 35 was processed with the first nucleation gas, i.e., carbon dioxide gas, at a rate of 8.5 L/min and the second nucleation gas, i.e., nitrogen gas, at a rate of 3 L/min. The first cell structure is shown in FIG. 3 as the smaller, uniform cells. The second cell structure is shown in FIG. 3 as the larger, random cells.

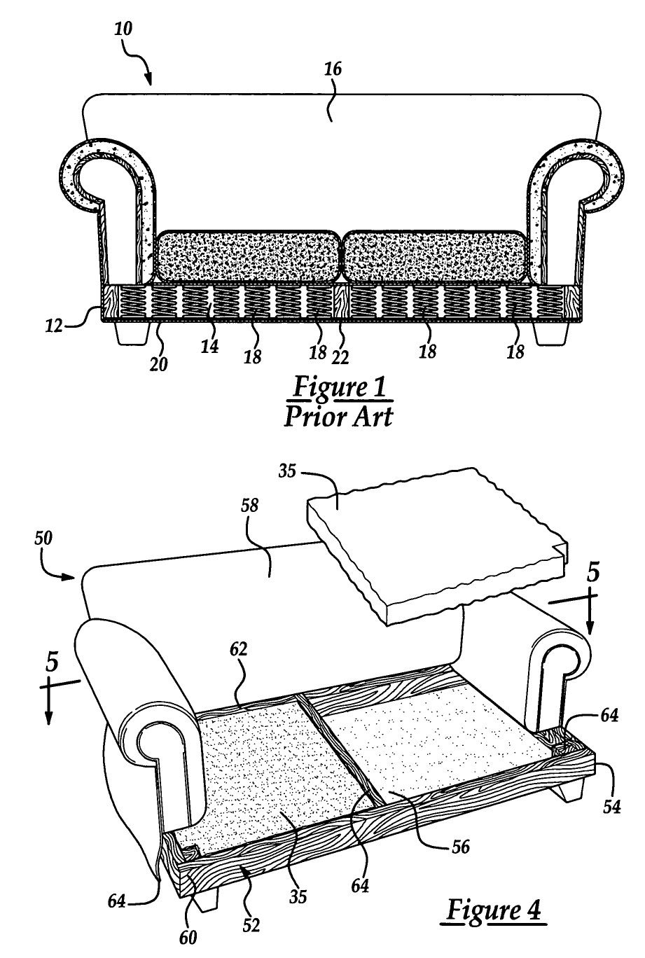

Referring again to the prior art FIG. 1, the article of furniture 10 is shown having the metal springs 18 disposed within the cavity 14 and was tested for IFD values. The metal springs were observed to have 11 lbs of 25% IFD value, 39 lbs of 65% IFD value, support factor or SAG factor of 3.5 and only 2% hysteresis loss. The metal springs 18 were then removed from the article of furniture 10 and the foamed article 35 according to the subject invention replaced one half of the metals springs 18 in the article of furniture 10. The other half of the metal springs 18 remained for a comparison study.

The processing conditions for the foamed article 35 used in the comparison study included the first nucleation gas added at a rate of about 10 L/min and the second nucleation gas at a rate of about 3 L/min. The foamed article 35 had a density of about 4 pcf, a 25% IFD value of 28, falling-ball resilience of 56% and a sag factor of 2.39.

In a study of user reactions to the comfort and feel of the article of furniture 50 having both the foamed article 35 on one side and the metal springs on the other, 40% preferred the side with the foamed article 35. Of those tested, 30% preferred the side with the metal springs or the metal spring network and 30% indicated that both sides felt the same. Each of the users where then asked to rate the comfort and feel of each of the sides of the couch on a scale from 1 to 5. The scale was as follows: 1 was unsatisfactory, 2 was marginal, 3 was solid/good, 4 was exceptional, and 5 was superior. The side of the couch with the metal springs received an average rating of 3.07. The side of the couch with the foamed article 35 received an average rating of 3.31. Based upon these results, the foamed article 35 produces a comfort and feel that is comparable and that exceeds that of the traditional metal springs.

Obviously, many modifications and variations of the present invention are possible in light of the above teachings. The invention may be practiced otherwise than as specifically described within the scope of the appended claims.

1. A foamed article having random cell structures formed by a process comprising the steps of:
providing a resin component and an isocyanate component;
providing a first nucleation gas under low pressure;
adding the first nucleation gas into at least one of the resin component and the isocyanate component;
providing a second nucleation gas under low pressure different than the first nucleation gas under low pressure;
adding the second nucleation gas into at least one of the resin component and the isocyanate component;
reacting the resin component and the isocyanate component to form said foamed article having a first cell structure resulting from the addition of the first nucleation gas and a second cell structure that is different then the first cell structure resulting from the addition of the second nucleation gas.

2. A foamed article as set forth in claim 1 wherein the first nucleation gas is selected from at least one of carbon dioxide gas and nitrogen gas.

3. A foamed article as set forth in claim 1 wherein the second nucleation gas is selected from at least one of carbon dioxide gas and nitrogen gas.

4. A foamed article as set forth in claim 1 wherein the first nucleation gas and the second nucleation gas are added in a ratio of from 1:1 to 1:10 respectively.

5. A foamed article as set forth in claim 1 wherein the first nucleation gas and the second nucleation gas are added in a ratio of from 1:1 to 1:4 respectively.

6. A foamed article as set forth in claim 1 wherein the step of adding the first nucleation gas is further defined as adding the first nucleation gas into the resin component.

7. A foamed article as set forth in claim 6 wherein the step of adding the second nucleation gas is further defined as adding the second nucleation gas into the isocyanate-reactive component.

8. A foamed article as set forth in claim 1 wherein the step of adding the first nucleation gas is further defined as adding the first nucleation gas prior to the addition of the second nucleation gas.

9. A foamed article as set forth in claim 1 wherein the step of adding the first nucleation gas is further defined as adding the first nucleation gas into the resin component.

10. A foamed article as set forth in claim 9 wherein the step of adding the second nucleation gas is further defined as adding the second nucleation gas into the isocyanate component.

11. A foamed article as set forth in claim 10 further comprising the step of mixing the resin component having the first nucleation gas and the isocyanate component having the second nucleation gas through a mix head to initiate the reaction.

12. A foamed article as set forth in claim 1 wherein the step of adding the first nucleation gas is further defined as adding the first nucleation gas at a rate of from 0.1 liters per minute to 30 liters per minute.

13. A foamed article as set forth in claim 1 wherein the step of adding the second nucleation gas is further defined as adding the second nucleation gas at a rate of from 0.1 liters per minute to 20 liters per minute.

14. A foamed article as set forth in claim 1 wherein the isocyanate component is selected from at least one of diphenylmethane diisocyanate, toluene diisocyanate, hexamethylene diisocyanate, isophorone diisocyanate, and mixtures thereof.

15. A foamed article as set forth in claim 1 wherein the resin component includes an isocyanate-reactive component selected from at least one of polyether polyols, polyamine polyols, and polyester polyols.

16. A foamed article as set forth in claim 1 wherein the resin component comprises a graft dispersion having a solids content of from 15 to 45 parts by weight based on 100 parts of the graft dispersion.

17. A foamed article as set forth in claim 1 wherein said foamed article is a high resilience polyurethane foam.

18. A foamed article as set forth in claim 1 wherein said foamed article has a density of greater than about 4 pounds per cubic foot.

19. A foamed article as set forth in claim 18 wherein said foamed article has a sag factor of from 2.0 to 3.5.

20. A foamed article as set forth in claim 19 wherein said foamed article has resilience of greater than 45% based on a steel ball rebound test.

21. A foamed article as set forth in claim 20 wherein said foamed article has an indentation force deflection of from 20 pounds to 32 pounds for achieving a 25% indentation.

22. An article of furniture comprising:
a frame having a base portion defining a cavity free of metal springs with a back portion extending upwardly from said base portion;
a foamed article disposed within said cavity and having a first cell structure and a second cell structure different than said first cell structure, wherein said first cell structure is formed as a result of a first nucleation gas added during formation of said foamed article and said second cell structure is formed as a result of a second nucleation gas different than said first nucleation gas added during formation of said foamed article.

23. An article of furniture as set forth in claim 22 wherein said foamed article has a density of greater than about 4 pounds per cubic foot.

24. An article of furniture as set forth in claim 23 wherein said foamed article has a sag factor of from 2.0 to 3.5.

25. An article of furniture as set forth in claim 24 wherein said foamed article has resilience of greater than 45% based on a steel ball rebound test.

26. An article of furniture as set forth in claim 25 wherein said foamed article has an indentation force deflection of from 20 pounds to 32 pounds for achieving a 25% indentation.

27. An article of furniture as set forth in claim 22 wherein said base portion comprises a front support, a rear support, and side supports defining said cavity.

28. An article of furniture as set forth in claim 27 wherein said foamed article is co-extensive with said front support, said rear support, and said side supports.

29. An article of furniture as set forth in claim 28 further comprising a bottom support engaging said front support, said rear support, and said side supports for supporting said foamed article within said cavity.

30. An article of furniture as set forth in claim 29 further comprising a cover engaging said front support, said rear support, and said side supports for covering said cavity and said foamed article.

31. An article of furniture as set forth in claim 29 wherein said bottom support is a fabric stretched between said front support, said rear support, and said side supports.

32. A composition for forming a foamed article having random cell structures, said composition comprising:
a resin component including an isocyanate-reactive component and a graft dispersion;
an isocyanate component;
a first nucleation gas disposed in one of said resin component or said isocyanate component while said first nucleation gas is in a gaseous state for forming a first cell structure in the foamed article;
a second nucleation gas different than said first nucleation gas disposed in one of said resin component or said isocyanate component while said second nucleation gas is in a gaseous state for forming a second cell structure in the foamed article that is different than said first cell structure, wherein said first and said second cell structures increases the physical properties of the foamed.

33. A composition as set forth in claim 32 wherein said isocyanate component is selected from at least one of diphenylmethane diisocyanate, toluene diisocyanate, hexamethylene diisocyanate, isophorone diisocyanate, and mixtures thereof.

34. A composition as set forth in claim 32 wherein said isocyanate-reactive component is selected from at least one of polyether polyols and polyester polyols.

35. A composition as set forth in claim 34 wherein said polyether polyol has a hydroxyl number of from 20 to 40, a functionality of from 1 to 4, and an ethylene oxide content of less than 30%.

36. A composition as set forth in claim 32 wherein said graft dispersion comprises at least one of polyacrylonitrile or polystyrene and has a solids content of from 15 to 45 parts by weight based on 100 parts by weight of said graft dispersion.

37. A composition as set forth in claim 36 wherein said graft dispersion has a hydroxyl number of less than 45.

38. A composition as set forth in claim 32 wherein the first nucleation gas is selected from at least one of carbon dioxide gas and nitrogen gas.

39. A composition as set forth in claim 32 wherein the second nucleation gas is selected from at least one of carbon dioxide gas and nitrogen gas.

40. A composition as set forth in claim 32 wherein the first nucleation gas and the second nucleation gas are added in a ratio of from 1:1 to 1:10 respectively.

41. A composition as set forth in claim 32 wherein the first nucleation gas and the second nucleation gas are added in a ratio of from 1:1 to 1:4 respectively.
